(19) United States
(12) Patent Application Publication
(10) Pub. No.: US 2014/0149346 A1
(43) Pub. Date: May 29, 2014

(54) SYSTEM AND METHOD FOR MAINTAINING DISTRIBUTED DATA TRANSACTION ATOMICITY AND ISOLATION DURING A REPLICATION TO A DIFFERENT TARGET CLUSTER

(71) Applicants: Eitan Yanovsky, Ra'ananna (IL); Idan Moyal, Ramat Gan (IL)

(72) Inventors: Eitan Yanovsky, Ra'ananna (IL); Idan Moyal, Ramat Gan (IL)

(73) Assignee: GigaSpaces Ltd., Hertzlia (IL)

(21) Appl. No.: 13/406,547

(22) Filed: Feb. 28, 2012

(51) Int. Cl. G06F 17/30

(52) U.S. Cl. CPC G06F 17/30227
USPC 707/615

(57) ABSTRACT

A replicator system and method to maintain the ACID characteristics of a transaction upon an asynchronous replication from a cluster to a different cluster.

Data transactions need to be ACID—atomic, consistent, isolated and durable. Let's take the example of two transfers of funds. The first transfer is in the sum of $100 from account A to account B under the assumption that there is money in account A. The second transfer is from account C to account A, also in the sum of $100. Assume the first transaction takes place before the second. Where both transactions have two parts. In the first transaction it is A=A−100 and B=B+100. All transaction parts (e.g. A−100, B+100) need to be guaranteed to be executed together.

In a distributed system there is a cluster of storage nodes. A transaction can have many parts, and in a distributed system they are executed preferably on different node—which can be of different types, remote from each other.

FIG. 1 shows a previous version of an art cluster storage system. The application 11 requests a transaction from proxy 12. Proxy 12 will assign each transaction part to a different node 14, and the whole transaction to the transaction manager 13. Transaction manager 13 will log the transactions participants and will send a COMMIT instruction to the transaction participating nodes 14 in order to instruct the nodes to perform the storage operation implied by the transaction part of each node in the storage nodes. The cluster storage system will guarantee all transactions are ACID.

### BRIEF DESRCPTION OF THE DRAWINGS

FIG. 1 is a description of a prior art cluster storage system;

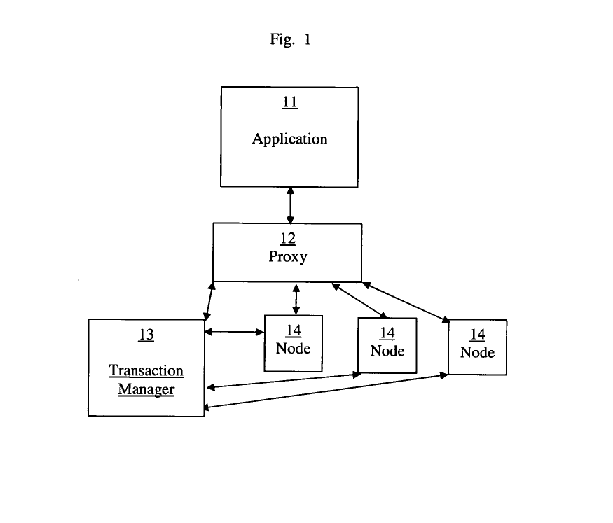

FIG. 2 is a description of the present invention transaction replication system;

FIG. 3 is a description of the operations in the invention replication system;

FIG. 4 is a description of an operation flow chart upon reception of a new item in a node queue; and

FIG. 5 is a description of a flow chart of a scan operation in a node queue.

### DETAILED DESCRIPTION OF THE INVENTION

The purpose of the present invention is to allow the replication of transactions between different clusters. This will enable the relevant applications to run in a different system for backup or load sharing purposes. One needs the atomicity of the distributed transaction to be maintained after the replication of the transaction to the other cluster. Additionally, the order of changes made to each specific data element needs to be maintained among the replicated transactions. Also, the process needs to be completed in a timely manner.

Typically in a cluster, each node is independent and therefore replicates its data state independently from the other nodes. This is the common way of making scalability possible. As a result, each part of the transaction that belongs to a single node arrives independently and asynchronously to the other parts. This makes it difficult to execute the transaction on the target cluster as the original single distributed transaction (atomicity).

Moreover, when multiple transactions are executed at the same time, each node may handle its part of the transaction in a different order than the other nodes.

The system and method described in this invention will show how a replication can be performed in a distributed system with the ACID characteristics maintained.

It will be based on a replicator which will gather the source cluster 1 node 14 transaction part outputs, will collect them together to form an atomic transaction and will handle the dependencies between transactions. The process will be done effectively for a quick operation.

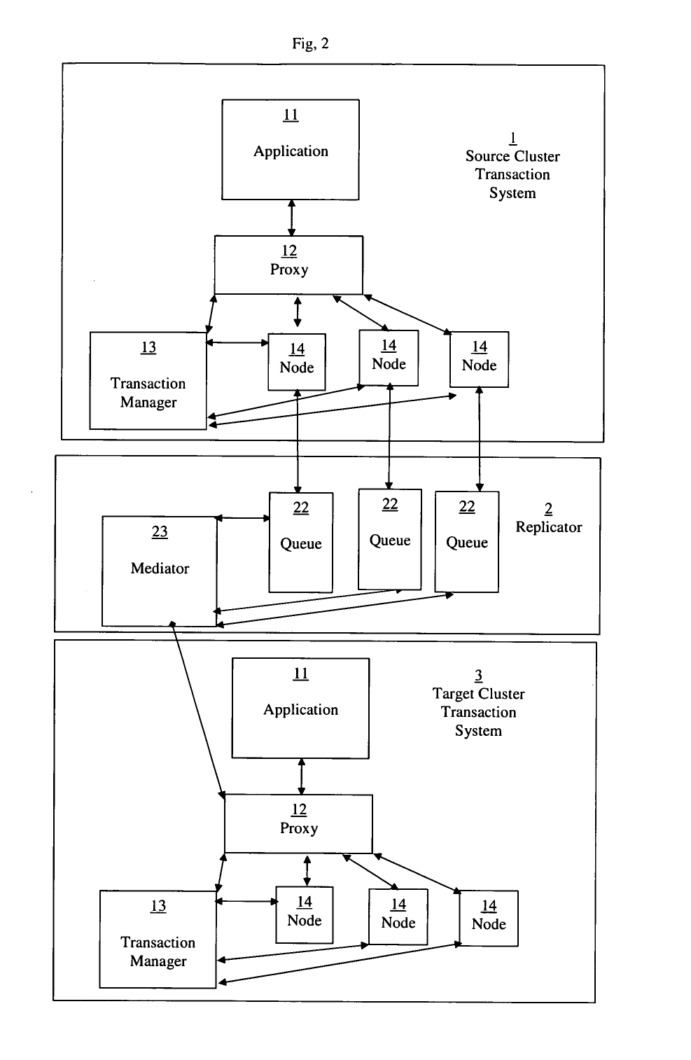

FIG. 2 presents an example of a transaction replication system. Source cluster 1 is connected via replicator 2 to a target cluster. Both source and target cluster are built according to the prior art description. The replicator gathers the outputs of storage node 14 from source cluster 1, organizes them properly and transfers them as new atomic and isolated transactions to the proxy 12 of target cluster 2. It has queues 22 which can store many items per node in source cluster 1 and a mediator. The mediator is connected to the proxy 12 in the target cluster 3 and manages the queues. The replicator will manage the collection of the stored transaction parts in nodes 14 in the source cluster and transfer them via the proxy 12 to target cluster 3 in a way which will maintain the ACID characteristics of the transactions.

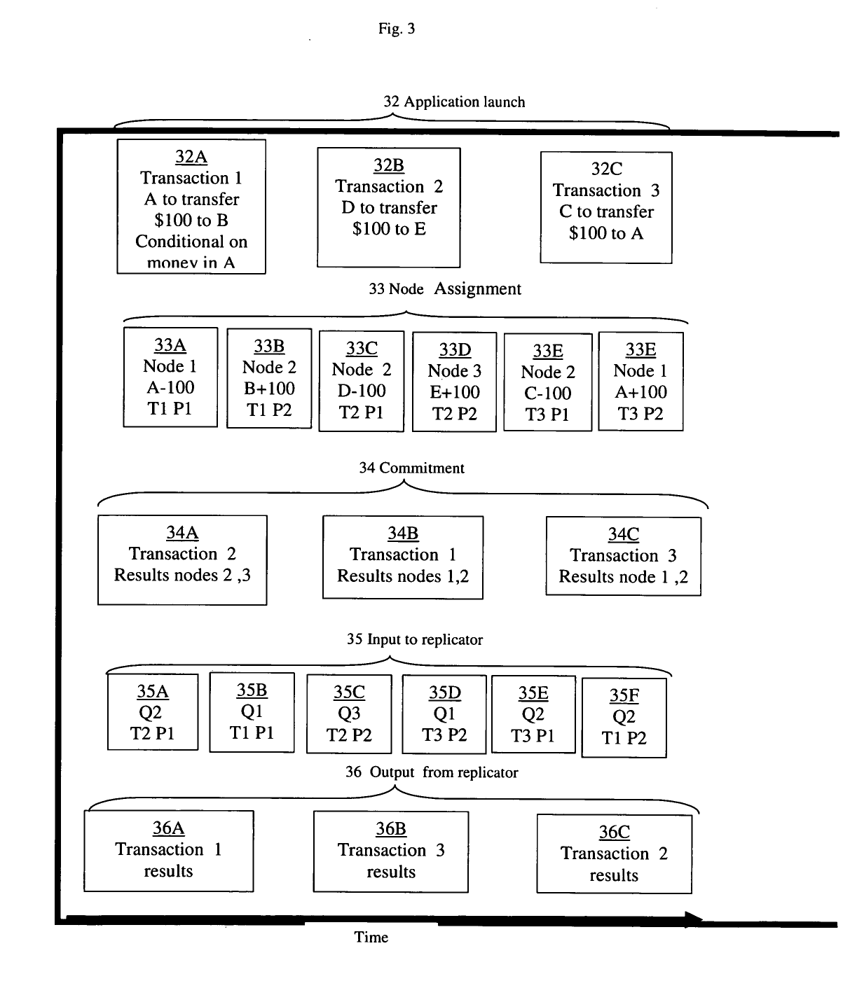

The system operations are described in FIG. 3.

In the example described, there are 3 transactions:

1. Transaction 1: 32A—A to transfer $100 to B conditional on having sufficient funds at A.

2. Transaction 2: 32B—D to transfer $100 to E.

3. Transaction 3: 32C—C to transfer $100 to A.

The application will handle the operations. (E.g. A−100)

Under the proxy supervision, nodes will receive assignments for transaction parts. Node #1 will receive 33A storing the result of A−100, part 1 of transaction 1, 32A. In addition, it will receive the assignment 33E, results of A+100, part 2 of transaction 3, 32C. Node #2 will receive assignment 33B, the result of B+100, part 2 of transaction 1, 32A. In addition, it will receive assignment 33C, D−100, part 1 of transaction 2, 32B. In addition it will receive assignment 33E, C−10, part 1 of transaction 3, 32C. Node #3 will receive the assignment 33D, E+100, part 1 of assignment 3, 32C.

In the next step, under the proxy supervision, the transactions will be committed—the storage of all application parts will be committed at the same time.

First transaction 2 will be committed in nodes 2 and 3. Then transaction 1 will be committed in nodes 1 and 2, and transaction 3 will then be committed in nodes 1 and 2—all the processes have been detailed thus far under the prior art description.

Replicator queues 32 will receive inputs over time from relevant nodes 14 of the source cluster.

Event 35A: Q2 will receive transaction 2, 32B part 1, then;

Event 35B: Q1 will receive transaction 1, 32A part 1, then;

Event 35C: Q3 will receive transaction 2, 32B part 2, then;

Event 35D: Q1 will receive transaction 3, 32C part 2, then;

Event 35E: Q2 will receive transaction 3, 32C part 1, and finally;

Event 35F: Q2 will receive transaction 1, 32A part 2.

It is clear that the parts received by replicator 2 are not in order and cannot be sent directly to cluster 3, as the atomicity cannot be maintained.

The replicator 2 will perform the correct collection and ordering of the parts, and will then output event 36A transaction 1, event 36B transaction 3 and finally event 36C transaction 2, and these will all be executed on cluster 3 in this order.

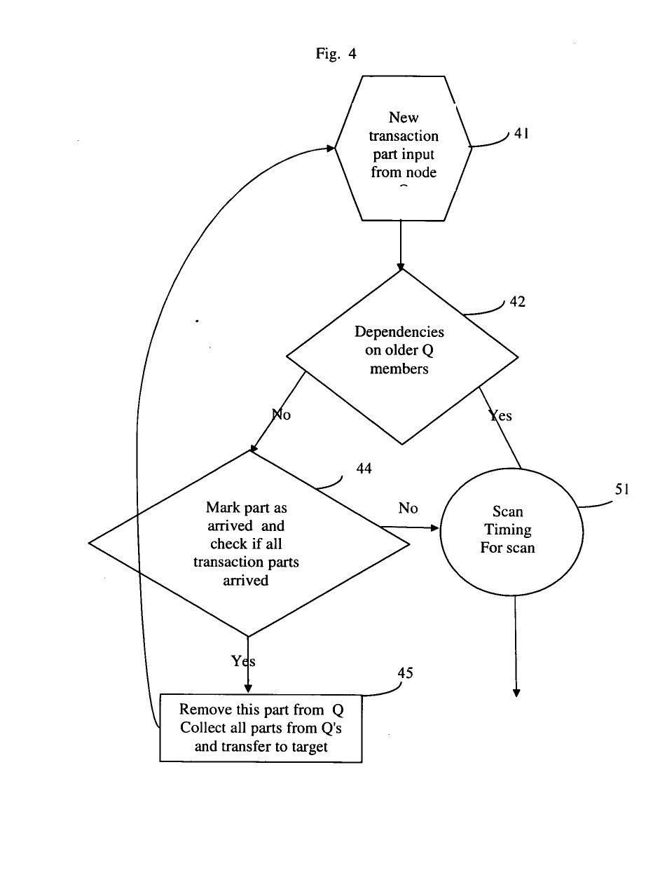

FIG. 4 details the flow chart in a queue 22 under the supervision of the mediator 21 when a new transaction part arrives in the queue from the relevant node. Such processes happen in parallel in each of these queues.

In step 41, a new item is received by the queue. It is received with the transaction number, part number and a serial node/queue number.

In step 42, it is determined whether this transaction part has dependencies on older transaction parts in the queue.

If it does, go to step 43, and wait for the scan operation.

If not, proceed to step 44. Mark it as arrived, and check if all other transaction parts arrived.

If not, this transaction part will be left to be handled by a scan operation (step 51).

If all of the transaction parts have arrived, with the help of the mediator, it will remove this part from the queue, and through the mediator will collect all other parts from the other queues and send the complete atomic transaction to cluster 3, and will go back to step 41 to wait for the next item.

The purpose of the process in this flow chart is to enable quick processing of new items.

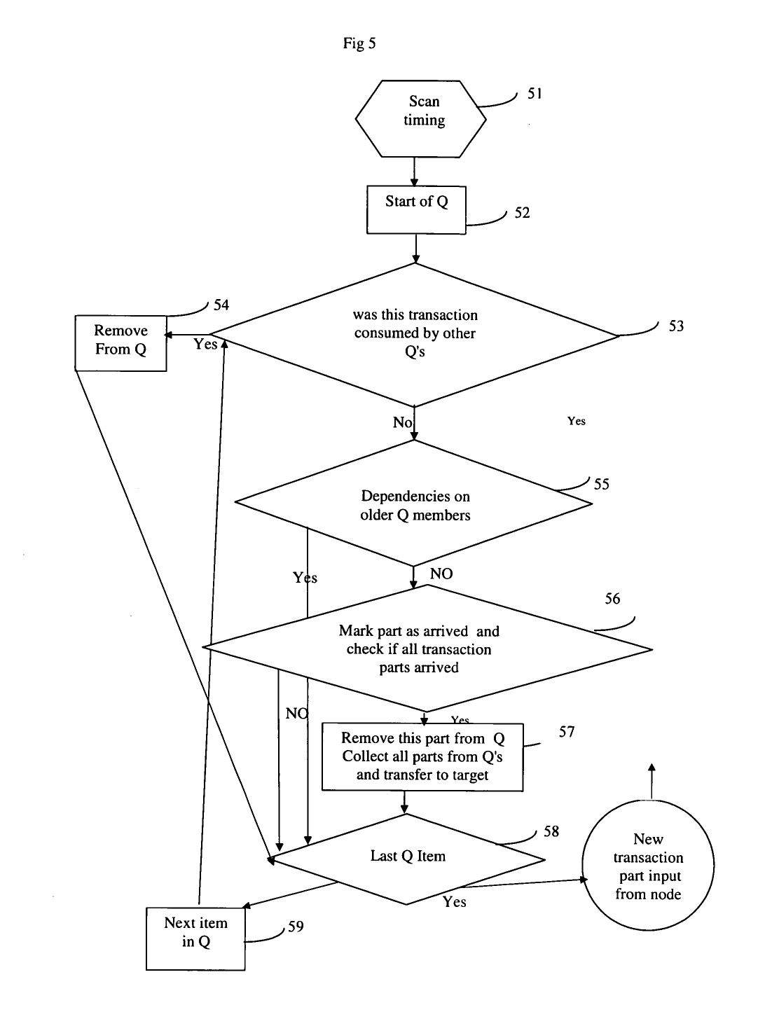

In a regular flow, as described in FIG. 5, a scan operation on all queue 22 items takes place every timeslot.

When this timeslot arrives (step 51), the item at the beginning of the queue (the oldest item) is examined in step 52.

In step 53, the mediator is polled to see whether this transaction was already consumed by other queues. If the answer is yes, then the part will be removed from the queue in step 54, and the process will move to step 58, to check if there are more items in the queue.

If the answer is no (step 53), the process will proceed to step 55, to check if there are dependencies on older transaction parts in the queue. If the answer is yes, it will proceed to step 58, to check if there are more items in the queue. If the answer is no (step 55) the process will proceed to step 56.

In step 56, the transaction part will be marked as arrived, and the mediator is then polled to see if all the transactions parts have arrived. If they have not, the process will proceed to step 58 to check if there are more items in the queue. If they have, then the process will proceed to step 57. This step serves to remove the part from the queue, and collects all other transaction parts, and through the mediator sends the complete atomic transaction parts to cluster 3, the target cluster.

In step 58, it is determined whether there are more items in the queue. If there are, in step 59 the next transaction part in the queue will be selected and the flow will then return to step 53. If there are not, then the flow will go back to step 41 (in FIG. 4) to wait for a new item to arrive.

The whole process will guarantee that the replicator can properly gather the transaction parts from the nodes and form transactions to be stored in the target cluster which will maintain the required atomicity and isolation characteristics.

What is claimed is:

1. A system for enabling replication of data transaction, comprised of a source storage cluster, a replicator and a target storage cluster where data transactions are generated in the source system and the replicator collects the outputs from the storage nodes to form an atomic transaction transferred to the target cluster.

2. A replicator system according to claim 1, wherein the replicator guarantees that the transaction storage order to the target cluster will be according to dependencies between transactions.

3. A replicator system according to claim 1, wherein the replicator enables the formation of a transaction to be stored in the target cluster based on a new item output from the source cluster

4. A replicator system according to claim 1, wherein the replicator is comprised of a queue per storage node, collecting the outputs of each such node and a mediator to control the queues.

5. A replicator system according to claim 4, wherein each queue is able to collect all transaction parts from all queues and form an atomic transaction.

6. A replicator system according to claim 4, wherein each queue checks the transaction part dependencies on other parts in the queue

7. A method for collecting transaction part outputs from a source cluster to form an atomic transaction to be stored in a target cluster

8. A method according to claim 7, wherein the transaction storage order to the target cluster will be according to dependencies between transactions.
